(19) United States
(12) Patent Application Publication
(10) Pub. No.: US 2020/0056539 A1
(43) Pub. Date: Feb. 20, 2020

(54) ACOUSTIC SHIELD FOR A MOTOR VEHICLE ENGINE

(71) Applicant: TREVES PRODUCTS, SERVICES & INNOVATION, Paris (FR)

(72) Inventors: Laurent WAXIN, Reims (FR); Christophe CAPRON, Reims (FR); François CHOQUART, Reims (FR)

(21) Appl. No.: 16/487,504

(22) PCT Filed: Feb. 20, 2018
(86) PCT No.: PCT/FR2018/050402

§ 371 Date: Aug. 21, 2019

(30) Foreign Application Priority Data
Feb. 24, 2017 (FR) 1751516
Apr. 3, 2017 (FR) 1752852

(51) Int. Cl. F02B 77/13; B29C 70/42; B60R 13/08; G10K 11/162

(52) U.S. Cl. CPC F02B 77/13; B29C 70/42; B29K 2309/08; B60R 13/0876; G10K 11/162; B60R 13/0838

(57) ABSTRACT

The invention relates to an acoustic sheild having a thermo-compressed shell based on fibres bound together by a thermoplastic binder to form a porous shell that has noise absorption properties. The shell has an internal face and an external face, and a sheet of metal for thermal protection against the engine. The sheet covers all or part of the internal face, the sheet is attached in a substantially fluidtight manner, essentially via its periphery to the shell. This creates a peripheral seal and maintains, except at the periphery, an air gap between the sheet and the shell, to protect the shell from the heat accumulated by the sheet.

### CROSS-REFERENCE TO RELATED APPLICATIONS

This application claims the benefit of International application number PCT/FR2018/050402, filed Feb. 20, 2018 and French application number 1751516, filed Feb. 24, 2017 and French application number 1752852, filed Apr. 3, 2017 the entire contents of which are incorporated herein by reference.

### TECHNICAL FIELD

The invention relates to an acoustic shield for a motor vehicle engine.

### BACKGROUND

It is known, in particular from the document FR2923069, to produce an acoustic shield for a motor vehicle engine, the shield comprising:

a thermo-compressed shell based on fibres bound together by a thermoplastic binder so as to form a porous shell that has noise absorption properties, the shell comprising an internal face and an external face,

a sheet of metal for thermal protection against the engine, the sheet covering all or part of the internal face.

Such a shield has the advantage of being lightweight, unlike shields in which the shell is based on an injection-moulded plastic material, and also of having noise absorption properties without requiring the addition of an absorbent layer, due to the intrinsic porosity of the shell.

However, due to the porous nature of the shell, it is subject to fluid uptake.

In addition, the attachment of the sheet of metal is difficult, due to the creation of thermal bridges where the sheet is attached to the shell, the presence of such bridges carrying the risk of degrading the shell.

Moreover, in a particular case in which the shell has at least one cutout forming an opening for heat extraction, the edge of the shell at the periphery of the opening is not protected from heat, leading to an additional risk of degradation of the shell.

Furthermore, in the event of fording, such an opening creates a risk that the water will rush in between the sheet and the shell, which may cause the sheet to tear or be pulled off.

### SUMMARY OF THE INVENTION

The invention is intended to overcome these disadvantages.

To this end, the invention proposes an acoustic shield for a motor vehicle engine, the shield comprising:

a thermo-compressed shell based on fibres bound together by a thermoplastic binder so as to form a porous shell that has noise absorption properties, the shell comprising an internal face and an external face,

a sheet of metal for thermal protection against the engine, the sheet covering all or part of the internal face,

the sheet being attached in a substantially fluidtight manner, essentially via its periphery, to the shell, so as to create a peripheral seal and maintain, except at the periphery, an air gap between the sheet and the shell, so as to protect the shell from the heat accumulated by the sheet.

It will be seen below that the sheet may be smooth or bumpy.

In the case of a smooth sheet, the applicant has observed, surprisingly, that the air gap, in spite of its thickness, which may be very fine—in particular less than 1 mm—, enables the shell to be very effectively protected from the heat accumulated by the sheet of metal.

Moreover, due to the smoothness of the sheet of metal, a shield having reduced thickness is provided, which allows it to be adapted to vehicle structures that have little space for receiving the shield.

It is also possible, as described below, for the sheet to be bumpy in order to allow an air gap having an accentuated thickness to be created.

With such an arrangement, the contact between the sheet and the shell occurs only at the end of the bumps, in particular in a substantially sporadic manner when the bumps have a general dome shape, enabling thermal bridges to be minimized.

The result is a very limited contact surface between the sheet and the shell, enabling degradation of the latter by heat stored by the sheet to be avoided.

And in every case:

the fact that the sheet is attached by its periphery in a substantially fluidtight manner to the shell makes it possible to prevent fluids from entering between the sheet and the shell,

in addition, the vehicle designer is free to make the periphery of the sheet correspond to an area of the shell with little exposure to heat, allowing for a robust attachment owing to its location in a cold area of the shell,

finally, in the particular situation in which the shell has at least one cutout forming an opening for heat extraction, it will be seen below that the invention allows the edge of the shell at the periphery of the opening to be protected from heat, and also, in the event of fording, to prevent water from rushing in between the sheet and the shell at the level of the opening, thereby avoiding the risk of the sheet being torn or pulled off.

### BRIEF DESCRIPTION OF THE DRAWINGS

Other features and advantages of the invention will appear in the following description, provided with reference to the appended figures, wherein:

FIG. 1 is a schematic partial front view, on the external face side, of a shield according to an embodiment,

FIG. 2 is a schematic partial cross-section view of the shield of FIG. 1 according to a first embodiment,

FIG. 3 is a schematic partial cross-section view of the shield of FIG. 1 according to a second embodiment.

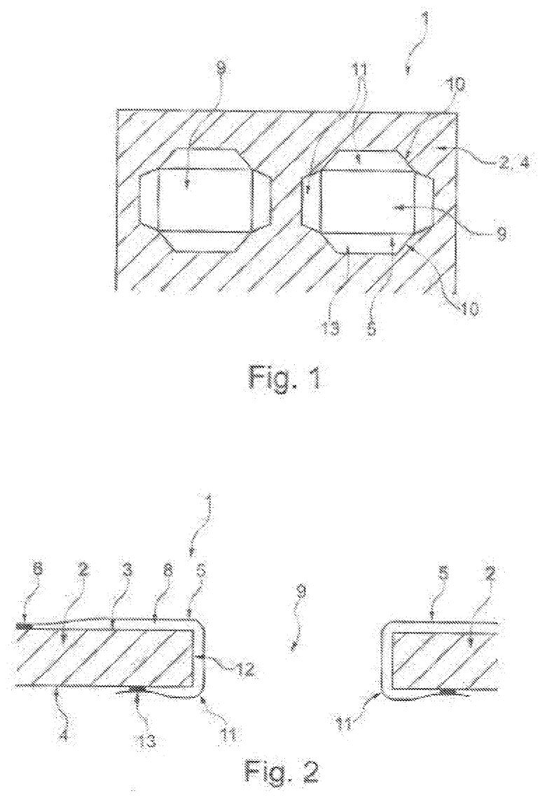

### DETAILED DESCRIPTION

In reference to the figures, an acoustic shield 1 for a motor vehicle engine will now be described, the shield being intended in particular to be mounted below the engine of the vehicle, the shield comprising:

a thermo-compressed shell 2 based on fibres bound together by a thermoplastic binder so as to form a porous shell that has noise absorption properties, the shell comprising an internal face 3 and an external face 4,

a sheet 5 of metal for thermal protection against the engine, the sheet covering all or part of the internal face,

the sheet being attached in a substantially fluidtight manner, essentially via its periphery 6, to the shell, so as to create a peripheral seal and maintain, except at the periphery, an air gap 8 between the sheet and the shell, so as to protect the shell from the heat accumulated by the sheet.

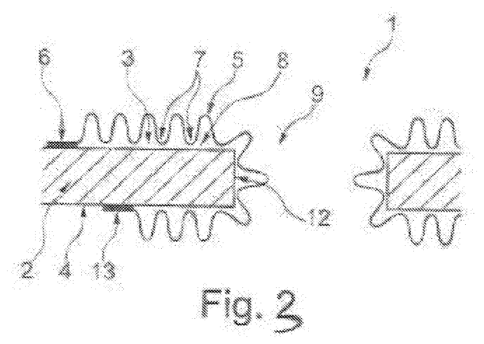

According to the embodiment of FIG. 2, the sheet 5 is smooth.

It is noted here that, in this case, the air gap 8 makes it possible, in spite of its thickness, which may be very fine, to very effectively protect the shell 2 from the heat accumulated by the sheet 5 of metal.

In this case, the air gap 8 may in particular generally have a thickness of less than 1 mm.

According to the embodiment of FIG. 3, which enables an air gap 8 having an accentuated thickness to be produced, the sheet 5 has a plurality of bumps 7 enabling it to be held generally apart from the internal face 3, so as to create the air gap.

In particular, the bumps 7 may be arranged in a regular array, in particular with a pitch of between 3 and 6 mm, so that the sheet 5 is goffered.

In a manner not shown, in particular when the sheet 5 is smooth, the shell 2 may have at least one area provided with a rib for spacing from the sheet 5, the rib originating from the internal face 3, so as to form an air gap 8 having an accentuated thickness in the area.

The shield 1 shown in the figures in its various embodiments also has the following features:

the shell 2 has at least one cutout in this case rectangular forming an opening 9 for heat extraction,

the sheet 5 has a plurality of incisions 10 defining sections 11, the sections being folded through the opening onto the external face 4 in order to cover the edge 12 of the shell 2 at the periphery of the opening, so that the air gap 8 also extends over the edge in order to protect it from heat,

the sections are attached to the external face in a substantially fluidtight manner.

According to the embodiments shown, the sections 11 are attached to the external face 4 via their periphery 13.

Such an arrangement enables a layer of air 8 to be created between the sheet 5 and the edge 12 of the shell 2 at the periphery of an opening 9.

As the attachment in this case is on the external face 4, it is not opposite the heat source, enabling its robustness to be optimized, in particular when the attachment is produced by welding.

According to one embodiment, the fibres of the shell 2 are based on glass, and the binder is based on polypropylene.

In particular, the shell 2 comprises between 40 and 60% by weight of glass fibres.

According to one embodiment, the sheet 5 has a thickness of between 50 and 150 microns.

According to one embodiment, the sheet 5 has an array of micro-perforations, the sheet having in particular between 200,000 and 600,000 micro-perforations/m², enabling the shell 2 to fully perform its role as an absorber of acoustic waves passing through the micro-perforations.

In particular, the micro-perforations are produced so that the sheet 5 is substantially impervious to fluids such as water or oil under ordinary conditions of use of a vehicle.

The micro-perforations may, for example, be circular and have a diameter of between 100 and 300 microns.

In a manner not shown, the shell 2 may have at least one slightly compressed area, intended for acoustic absorption, and at least one strongly compressed area, intended as a reinforcement.

In particular, the shell 2 may have, in a slightly compressed area, an airflow resistance of between 250 and 2500 N.s.m⁻³, the airflow resistance being measured according to standard ISO 9053/method B, with an alternating air flow.

According to one embodiment, the sheet 5 is attached at its periphery 6, and as the case may be at the level of the sections 11, by welding to the shell 2.

It is possible in particular for the sheet 5 to be coated on its back with a thermoplastic or thermosetting material in order to promote the welding.

According to an embodiment not shown, the shield 1 may also include a protective layer, in particular based on a nonwoven material, attached at the external face 4 of the shell 2.

Such a layer, to a certain extent, protects against water uptake by the external face 4 of the shell 2, and also enables any possible sections 11 to be hidden.

In a manner not shown, it may also be possible to insert, between the protective layer and the external face 4, a fluidtight film allowing for complete protection against water uptake.

What is claimed is:

1. An acoustic shield for a motor vehicle engine, the shield comprising:
a thermo-compressed shell based on fibres bound together by a thermoplastic binder to form a porous shell that has noise absorption properties, the shell comprising an internal face and an external face,
a sheet of metal for thermal protection against the engine, the sheet covering all or part of the internal face,
wherein the sheet is attached in a substantially fluidtight manner, essentially via its periphery, to the shell, to create a peripheral seal and maintain, except at the periphery, an air gap between the sheet and the shell, to protect the shell from the heat accumulated by the sheet.

2. The shield according to claim 1, wherein the sheet is smooth.

3. The shield according to claim 2, wherein the air gap generally has a thickness of less than 1 mm.

4. The shield according to claim 1, wherein the sheet has a plurality of bumps enabling it to be held generally apart from the internal face, to create an air gap having an accentuated thickness.

5. The shield according to claim 4, wherein the bumps are arranged in a regular array, with a pitch of between 3 and 6 mm, so that the sheet is goffered.

6. The shield according claims 1, wherein the shell has at least one area provided with a rib for spacing from the sheet, the rib originating from the internal face, to form an air gap having an accentuated thickness in the area.

7. The shield according to claim 1, wherein:
the shell has at least one cutout forming an opening for heat extraction,
the sheet has a plurality of incisions defining sections, the sections being folded through the opening onto the external face in order to cover the edge of the shell at the periphery of the opening, the air gap also extends over the edge in order to protect it from heat,
the sections are attached to the external face in a substantially fluidtight manner.

8. The shield according to claim 1, wherein the sheet has a thickness of between 50 and 150 microns.

9. The shield according to claim 1, wherein the sheet is provided with an array of micro-perforations, the sheet having between 200,000 and 600,000 micro-perforations/m².

10. The shield according to claim 7, wherein the sheet is attached at its periphery, and at the sections, by welding to the shell.
